(19) United States
(12) Patent Application Publication
(10) Pub. No.: US 2026/0187707 A1
(43) Pub. Date: Jul. 2, 2026

(54) PROCESSING METHOD AND APPARATUS FOR OBJECT INFORMATION

(71) Applicant: Beijing Zitiao Network Technology Co., Ltd., Beijing (CN)

(72) Inventors: Lei HE, Beijing (CN); Chunlin REN, Beijing (CN); Xin LIAO, Beijing (CN); Kang WANG, Beijing (CN); Dong NIU, Beijing (CN)

(21) Appl. No.: 19/412,428

(22) Filed: Dec. 8, 2025

(30) Foreign Application Priority Data
Dec. 30, 2024 (CN) 202411978261.0

(51) Int. Cl. G06Q 30/0601; G06F 21/10

(52) U.S. Cl. CPC G06Q 30/0641; G06F 21/1015

(57) ABSTRACT

A processing method for object information includes: presenting, in a first application interface, a sub object registration entry of a first target main object; and establishing, in response to receiving sub object registration information input by a first user based on the sub object registration entry, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects; where associated cooperation information with a second user is displayed in the first application interface, the associated cooperation information is used for indicating that introduction information and order information for the first target main object are presented in a second application interface of the second user.

### CROSS-REFERENCE TO RELATED APPLICATIONS

This application claims priority to Chinese Patent Application No. 202411978261.0 entitled “PROCESSING METHOD AND APPARATUS FOR OBJECT INFORMATION” and filed on Dec. 30, 2024, the disclosure of which is hereby incorporated by reference in its entirety.

### TECHNICAL FIELD

Embodiments of the present disclosure relate to the field of Internet technology, in particular to a processing method and apparatus for object information.

### BACKGROUND

With the development of Internet technology, more and more users know and purchase articles by a live platform. For example, order information for article A can be set in a live interface of an XX live room, and a user can purchase the article A according to the order information for the article A. In the related art, a merchant owning a plurality of stores can associate a n article with the plurality of stores, and a user can go to any of the stores for exchanging the alretic by an electronic voucher of the article after purchasing the article.

### SUMMARY

In a first aspect, an embodiment of the present disclosure provides a processing method for object information, including:
presenting, in a first application interface, a sub object registration entry of a first target main object; and
establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects;
where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

In a second aspect, an embodiment of the present disclosure provides a processing apparatus for object information, including:
a presentation unit configured to present, in a first application interface, a sub object registration entry of a first target main object; and
an information binding unit configured to establish, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects;
where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

In a third aspect, an embodiment of the present disclosure provides an electronic device, including: a processor and a memory, where
the memory has stored therein computer-executable instructions; and
the processor executes the computer-executable instructions stored in the memory to cause the processor to perform the processing method for object information as described above in the first aspect and various possible designs of the first aspect.

In a fourth aspect, an embodiment of the present disclosure provides a non-transitory computer-readable storage medium having stored therein computer-executable instructions which, when executed by a processor, implement the processing method for object information as described above in the first aspect and various possible designs of the first aspect.

In a fifth aspect, an embodiment of the present disclosure provides a computer program product, including a computer program that, when executed by a processor, implements the processing method for object information as described above in the first aspect and various possible designs of the first aspect.

### BRIEF DESCRIPTION OF THE DRAWINGS

In order to more clearly illustrate the technical solutions in the embodiments of the present disclosure or the related art, the drawings that need to be used in the description of the embodiments or the related art will be briefly described below, and it is apparent that the drawings in the following description are some of the embodiments of the present disclosure, and for one of ordinary skill in the art, other drawings can be obtained without paying creative labor.

FIG. 1 is a first flow diagram of a processing method for object information according to an embodiment of the present disclosure;

FIG. 2 is a first schematic diagram of a processing method for object information according to an embodiment of the present disclosure;

FIG. 3 is a flow diagram of creation of main object information according to an embodiment of the present disclosure;

FIG. 4 is a second schematic diagram of a processing method for object information according to an embodiment of the present disclosure;

FIG. 5 is a flow diagram of registration of a sub object according to an embodiment of the present disclosure;

FIG. 6 is a third schematic diagram of a processing method for object information according to an embodiment of the present disclosure;

FIG. 7 is a fourth schematic diagram of a processing method for object information according to an embodiment of the present disclosure;

FIG. 8 is a fifth schematic diagram of a processing method for object information according to an embodiment of the present disclosure;

FIG. 9 is a flow diagram of processing of a main-and-sub-objects binding relationship according to an embodiment of the present disclosure;

FIG. 10 is a schematic structural diagram of a processing apparatus for object information according to an embodiment of the present disclosure; and

FIG. 11 is a schematic structural diagram of an electronic device according to an embodiment of the present disclosure.

### DETAILED DESCRIPTION

To make the objectives, technical solutions and advantages of the embodiments of the present disclosure more apparent, the technical solutions in the embodiments of the present disclosure will be described clearly and completely below in conjunction with the drawings in the embodiments of the present disclosure, and it is obvious that the described embodiments are some of the embodiments of the present disclosure, but not all of them. All other embodiments, which can be obtained by one of ordinary skill in the art based on the embodiments in the present disclosure without making creative labor, are intended to be within the scope of protection of the present disclosure.

It should be noted that user information (including but not limited to user equipment information, user personal information, etc.) and data (including but not limited to data for analysis, stored data, presented data, etc.) involved in one or more embodiments of this description are all information and data authorized by users or sufficiently authorized by parties, and collection, use and processing of related data requires compliance with related laws and regulations and standards, and are provided with corresponding operation entries for the users to choose authorization or denial.

The embodiments of the present disclosure provide a method and an apparatus for processing object information, capable of increasing combination modes of main and sub objects, and improving the combination effect of the main and sub objects.

According to the processing method and apparatus for object information provided in th embodiment, the method includes: presenting, in a first application interface, a sub object registration entry of a first target main object; establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects; where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value. In this technical solution, since when a merchant user binds the sub object with the first target main object, the merchant user can participate by means of active registration, and the number of the sub objects bound with the first target main object can be increased by providing anchor promotion services for the merchant user, the binding mode of the main and sub objects is increased, and the combination effect of the main and sub objects is improved; moreover, it can be cross-industry and cross-merchant between the main object and the sub object, and the mode of binding between the main object and the sub object is more flexible, and thus the binding mode of the main and sub objects is further increased, and the combination effect of the main and sub objects is improved.

With the development of Internet technology, more and more users know and purchase articles by a live platform. For example, order information for article A can be set in a live interface of an XX live room, and a user can purchase the article A according to the order information for the article A.

In the related art, a merchant owning a plurality of stores can associate an article with the plurality of stores, and a user can go to any of the stores for exchanging the article by an electronic voucher of the article after purchasing the article.

Exemplarily, an XX optical shop has a plurality of stores, and can associate glasses package A with the plurality of stores. A user can go to any of the stores for exchanging the glasses package A after purchasing the glasses package A.

Exemplarily, an XX cake shop has a plurality of stores, and can associate cake A with the plurality of stores. A user can go to any of the stores for exchanging the cake A after purchasing the cake A.

However, the inventors have founded that in the related art, there are at least the following technical problems: when an article is associated with stores, only allowing combination between a headquarters merchant and its own stores, with a single combination mode and a poor combination effect.

For the technical problems in the related art, technical concepts of the inventors are as follows: combining articles of a plurality of cross-industry and cross-brand merchants into one main article to increase combination modes of the main and sub articles, while operating abilities of the merchants is increased by cooperating with experts (or Internet celebrities), and hence the number of sub articles of each main article is improved, and the combination effect of the main and sub articles is improved.

Correspondingly, specific steps may include: first, presenting, in a first application interface, a sub object registration entry of a first target main object; then, establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects; where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

In the related art, some small merchants or single-store merchants will not find experts to cooperate to increase operating abilities of the merchants due to cost problems. Moreover, the expert is not intend to market articles of the small merchants or the single-store merchants due to weak operating abilities of the small merchants or the single-store merchants. In the technical solutions of the present application, however, since when the merchant user binds the sub object with the first target main object, the merchant user can participate by means of active registration, and the number of the sub objects bound with the first target main object can be increased by providing anchor promotion services for the merchant user, the binding mode of the main and sub objects is increased, the combination effect of the main and sub objects is improved; moreover, it can be cross-industry and cross-merchant between the main object and the sub object, and the mode of binding between the main object and the sub object is more flexible, and thus the binding mode of the main and sub objects is further increased, and the combination effect of the main and sub objects is improved.

Specific implementations of a processing method and apparatus for object information involved in the embodiments of the present disclosure are described below, where some examples are only examples and are not limited. An execution subject of the processing method for object information involved in the embodiments of the present disclosure is an electronic device, which may be a terminal, server, or the like.

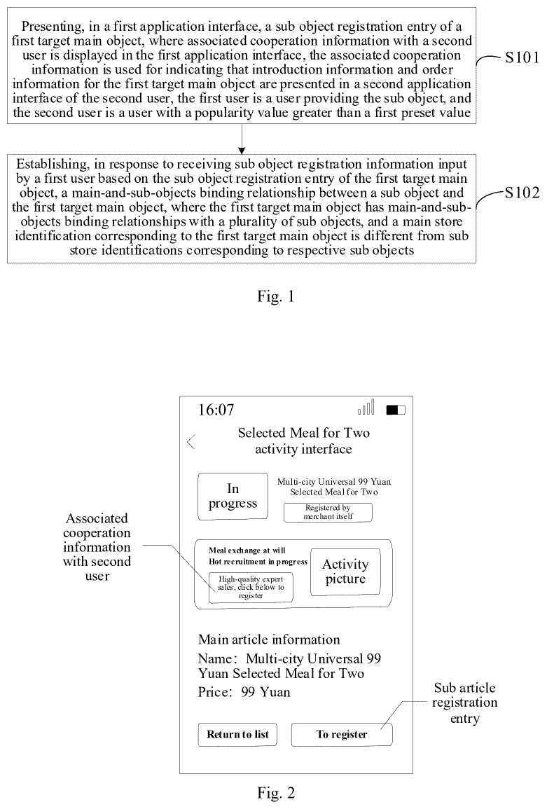

FIG. 1 is a first flow diagram of a processing method for object information according to an embodiment of the present disclosure; as shown in FIG. 1, the processing method for object information may include:
S101, presenting, in a first application interface, a sub object registration entry of a first target main object; where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

In the embodiment of the present disclosure, the first target main object may be any type of main object, such as dining, tourism, clothing, and accommodation. The first application interface may be an activity interface for the any type of main object. Optionally, in a preset area of the first application interface, the sub object registration entry of the first target main object is displayed. In this step, a position of the preset area is not specifically limited. Optionally, the preset area may be located on top or bottom of the first application interface.

Exemplarily, as shown in FIG. 2, a first target main object is: Multi-city Universal 99 Yuan Selected Meal for Two. A first application interface is a Selected Meal for Two activity interface, and the sub object registration entry of the first target main object is displayed in a preset area of the Selected Meal for Two activity interface. The preset area is located on the bottom of the Selected Meal for Two activity interface.

The first user is a user who provides the sub object. For example, a main object is a main article, a sub object is a sub article, and a first user is a merchant user who can provide the sub article. The second user is a user with a popularity value greater than a first preset value. For example, a second user is an anchor user.

Optionally, the second user is a user with a popularity value greater than a first preset value; where the popularity value is determined based on one or more of the number of users following the second user, the number of works published by the second user, the number of likes of the works published by the second user, the forwarding amount of the works published by the second user, and the number of comments of the works published by the second user. For example, the second user is an anchor expert.

In some embodiments, in a preset interface of an application, a main object activity list is displayed, which includes interface switching entries corresponding to a plurality of main object activity interfaces respectively. Exemplarily, the plurality of main object activity interfaces include: a Selected Meal for Two activity interface, Selected Meal for Three activity interface, Hot One-day Trip activity interface, Weekend Two-day Trip activity interface, and the like. The preset interface may be any interface of the application, for example, a homepage interface, mall interface, group purchase interface, and the like.

In some embodiments, presenting, in the first application interface, the sub object registration entry of the first target main object includes: receiving a main object creation request fo the first target main object, where the main object creation request carries main object information of the first target main object; and generating the order information for the first target main object according to the main object information, presenting, in the second application interface of the second user, the order information for the first target main object, and presenting an interface switching entry for the first application interface corresponding to the first target main object, and in response to a trigger operation on the interface switching entry, presenting the sub object registration entry of the first target main object in the first application interface. It should be noted that a main object activity in the main object activity list may be initiated by a platform or by a merchant user.

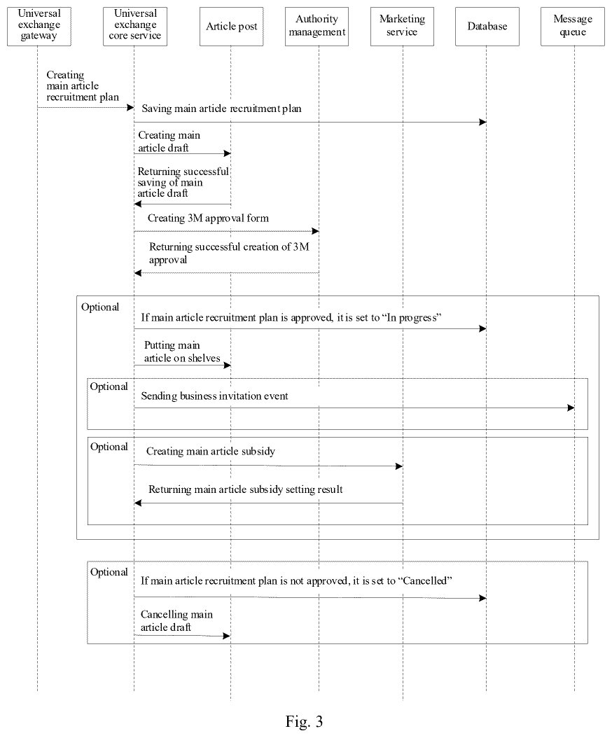

Exemplarily, as shown in FIGS. 2 and 3, a main object can be a main article. A platform or merchant can send creating a main article recruitment plan to a universal exchange gateway, and the universal exchange gateway sends the main article recruitment plan to a universal exchange core service. A main article draft and an approval form corresponding to the main article recruitment plan are created by the universal exchange core service. After the main article recruitment plan is approved, the main article can be put on shelves and a state of the main article recruitment plan is set to “In progress”. It should be noted that, as shown in FIG. 3, if the main article recruitment plan is not approved, the state of the main article recruitment plan is set to “Cancelled” and the main article draft is cancelled.

In some embodiments, as shown in FIG. 3, after the main object creation request for the first target main object is received, a business invitation event may also be sent to an eligible merchant. Correspondingly, the method further includes: sending sub object registration information for the first target main object to a first target user, where the sub object registration information is used for indicating sub object registration information to be input by the first target user based on the sub object registration entry of the first target main object, and the first target user is the first user meeting a sub object binding rule of the first target main object.

In some embodiments, after the main object creation request for the first target main object is received, main object resource deduction information corresponding to the first target main object may also be created. Exemplarily, as shown in FIG. 3, the main object resource deduction information may be a main article subsidy, and the main article subsidy is created after a main article creation request is received.

Optionally, the main object activity is initiated by the merchant user, and generating the first application interface may include: receiving the main object information of the first target main object input by a fourth user based on a main object creation interface, where the fourth user is another merchant user than the first user; determining the associated cooperation information with the second user corresponding to the first target main object; and generating the first application interface corresponding to the first target main object according to the main object information and the associated cooperation information with the second user.

In some embodiments, the second application interface includes a live interface of the second user or a short video interface of the second user; and the introduction information includes live introduction information related to the first target main object or short video introduction information related to the first target main object.

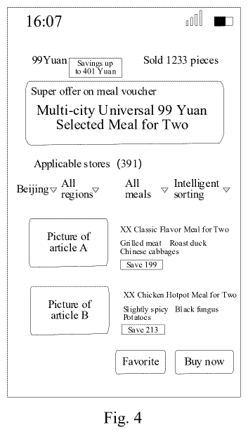

Optionally, the live introduction information or short video introduction information includes the order information for the first target main object. The order information may be an order entry for the first target main object. In response to an trigger operation on the order entry, a main object order interface for the first target main object is presented. Exemplarily, a first target main object is “99 Yuan Selected Meal for Two”, and a main object order interface of the first target main object is shown in FIG. 4.

In some embodiments, generating the order information for the first target main object includes: acquiring main object resource deduction information and sub object resource deduction information; and generating the order information for the first target main object according to the main object resource deduction information and the sub object resource deduction information.

Exemplarily, as shown in FIG. 4, order information for a first target main object generated according to main object resource deduction information and sub object resource deduction information is: “99 Yuan, Savings up to 401 Yuan”.

In the embodiment of the present disclosure, when a merchant user binds a sub object with a first target main object, the merchant user can actively register to participate, and by providing promotion services of an expert anchor for the merchant user, the number of the sub objects bound with the first target main object can be increased, and thus the combination mode of the main and sub objects is increased, and the combination effect of the main and sub objects improved.

It should be noted that, a user can also search by a keyword, and the introduction information and order information for the first target main object are presented in a search result interface. For example, a user inputs “Meal for Two” in a search box, and introduction information and order information for “99 Yuan Selected Meal for Two” are presented in a search result interface.
S102, establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects.

In the embodiment of the present disclosure, the main store identification corresponding to the first target main object may be a main store of a main article, for example, a Selected Meal for Two main store. The sub store identification corresponding to the sub object may be a sub store of a sub article, for example, an XX Chicken Hotpot store, XX Grilled Fish store, XX Hot Pot store.

Optionally, a sub object list corresponding to the first target main object includes sub object information of respective sub objects for which the main-and-sub-objects binding relationships are established with the first target main object. The sub object information in the sub object list may be updated in real time. Correspondingly, this step may include: presenting, in response to receiving a trigger operation on the sub object registration entry of the first target main object, a sub object registration interface, where the sub object registration interface includes a first entry for inputting the sub object and a second entry for inputting sub object information; acquiring the sub object input by the first user based on the first entry and the sub object information input by the first user based on the second entry; and establishing the main-and-sub-objects binding relationship between the sub object and the first target main object, and adding the sub object information into the sub object list corresponding to the first target main object.

It should be noted that the main object information may include the sub object binding rule. Before the main-and-sub-objects binding relationship between the sub object and the first target main object is established, the sub object may be verified by the sub object binding rule of the first target main object.

In some embodiments, this step may include: verifying, in response to receiving the sub object registration information input by the first user based on the sub object registration entry of the first target main object, the sub object based on the sub object binding rule of the first target main object; and establishing the main-and-sub-objects binding relationship between the sub object and the first target main object if the verifying is successful.

The sub object registration information includes a sub object identification, a sub object type, sub object resource information, and sub object historical interaction information; and the sub object binding rule include one or more of: the sub object identification including a preset character, the sub object type being a preset type, the sub object resource information being within a preset resource information range, and the sub object historical interaction information meeting a preset condition.

The sub object binding rule may include a rule of restricting any sub object attribute information. For example, a first target main object is “99 Yuan Selected Meal for Two”, and a sub object binding rule can include: the sub object type being “Meal for Two”, and a position of a store for exchanging the sub object being “XX city”.

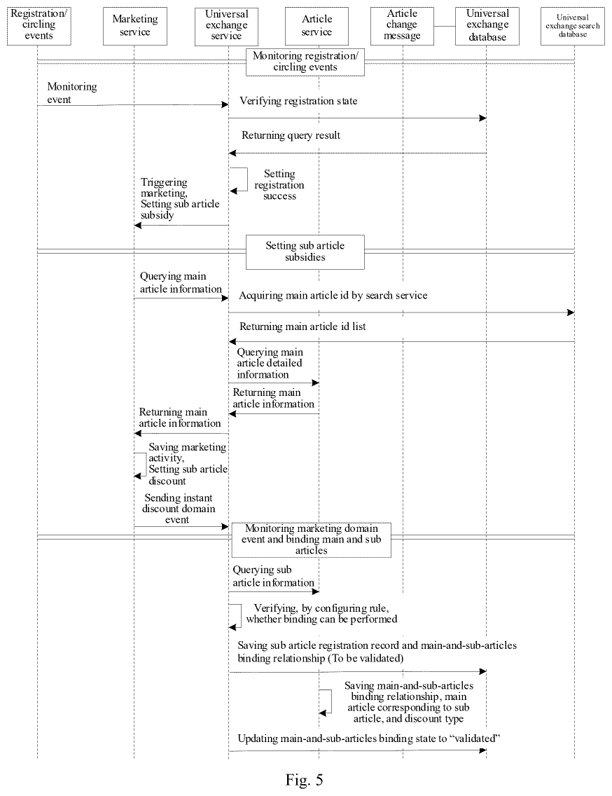

Exemplarily, as shown in FIG. 5, a main object is a main article, and a sub object is a sub article. It can be verified, by configuring the rule, whether the main article and the sub article can be bound. If it is verified that the main article and the sub article can be bound, a main-and-sub-articles binding relationship is stored, and a main-and-sub-articles binding state is updated to “Validated”.

In other embodiments, a sub article meeting the requirement can be automatically bound according to the sub article binding rule. Correspondingly, the method may further include: acquiring a candidate sub object meeting the sub object binding rule according to the sub object binding rule of the first target main object; and establishing a main-and-sub-objects binding relationship between the candidate sub object and the first target main object; or, sending a binding notification message to the first user corresponding to the candidate sub object, and establishing, in response to a confirmation operation of the first user based on the binding notification message, a main-and-sub-objects binding relationship between the candidate sub object and the first target main object.

It should be noted that, when the sub object registration information input by the first user based on the sub object registration entry of the first target main object is received, sub object resource deduction information corresponding to the sub object may also be created. Exemplarily, as shown in FIG. 5, a main object is a main article, and a sub object is a sub article. If a registration event of the sub article is monitored, a registration state is verified and registration success is set. A t this time, it is also possible to trigger marketing and set a sub article subsidy.

The embodiment of the present disclosure provides a processing method for object information, which includes: presenting, in a first application interface, a sub object registration entry of a first target main object; and establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects; where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value. In this technical solution, since when a merchant user binds the sub object with the first target main object, the merchant user can participate by means of active registration, and the number of the sub objects bound with the first target main object can be increased by providing anchor promotion services for the merchant user, the binding mode of the main and sub objects is increased, and the combination effect of the main and sub objects is improved; moreover, it can be cross-industry and cross-merchant between the main object and the sub object, and the mode of binding between the main object and the sub object is more flexible, and thus the binding mode of the main and sub objects is further increased, and the combination effect of the main and sub objects is improved.

In some embodiments, the method further includes: presenting, in a third application interface, an exchange entry of a second target main object, where the second target main object is a main object having already been ordered by a third user based on the order information, and the third user is a buyer user; presenting, in response to receiving a trigger operation on the exchange entry of the second target main object, sub object list information corresponding to the second target main object in a sub object exchange interface, where the sub object list information includes sub object information respective sub objects for which main-and-sub-objects binding relationships are established with the second target main object.

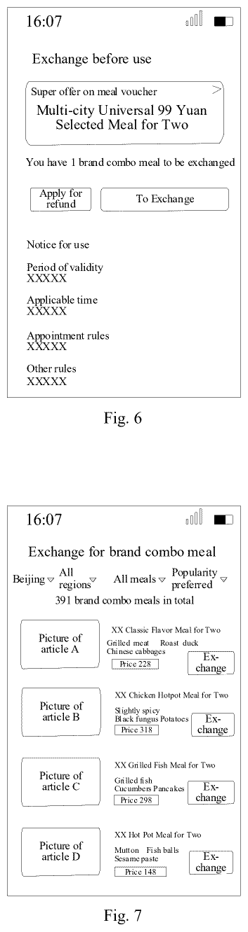

The third application interface may be a main article exchange interface. Exemplarily, as shown in FIG. 6, a second target main object is “Multi-city Universal 99 Yuan Selected Meal for Two”. An exchange entry of the “Multi-city Universal 99 Yuan Selected Meal for Two” is presented in the third application interface. The exchange entry can be a “To Exchange” icon. In response to receiving a trigger operation on “To Exchange”, in a sub object exchange interface, sub object list information corresponding to the second target main object is presented, as shown in FIG. 7.

Optionally, the sub object exchange interface may further include a search identification, by which a sub object for which exchange is intended can be searched, when there is a lot of sub object information of respective sub objects for which the main-and sub objects binding relationships have already been established with the second target main object. The search identification may be a search icon or a search box.

In some embodiments, the sub object information includes a sub object detailed introduction and a sub object exchange entry; and the method further includes: exchanging, in response to receiving a trigger operation on the sub object exchange entry, the sub object, and presenting use voucher information for the sub object, where the sub object exchange information of the sub object includes sub object resource information and object resource deduction information, and the object resource deduction information is a sum of main object resource deduction information of the second target main object and sub object resource deduction information of the sub object.

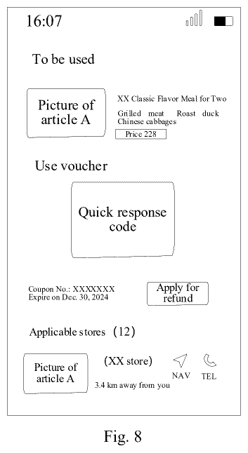

The use voucher information is used for completing a payment transaction for the sub object. Exemplarily, as shown in FIG. 8, the use voucher information for the sub object is an exchange quick response (QR) code.

It should be noted that in the embodiment of the present disclosure, the state of the main object, the state of the sub object, and the binding rule can be adjusted in real time, and when the main object and the sub object do not meet the binding rule, the binding relationship between the main object and the sub object can also be changed.

In some embodiments, the state of the main object or sub object changes. Correspondingly, the method may include: unbinding, in response to receiving event change information of the sub object, the main-and-sub-objects binding relationship between the sub object and the first target main object, where the event change information includes one or more of: the first user no longer providing the sub object, sub object resource information of the sub object being not within a preset resource information range, or historical interaction information of the sub object not meeting a preset condition.

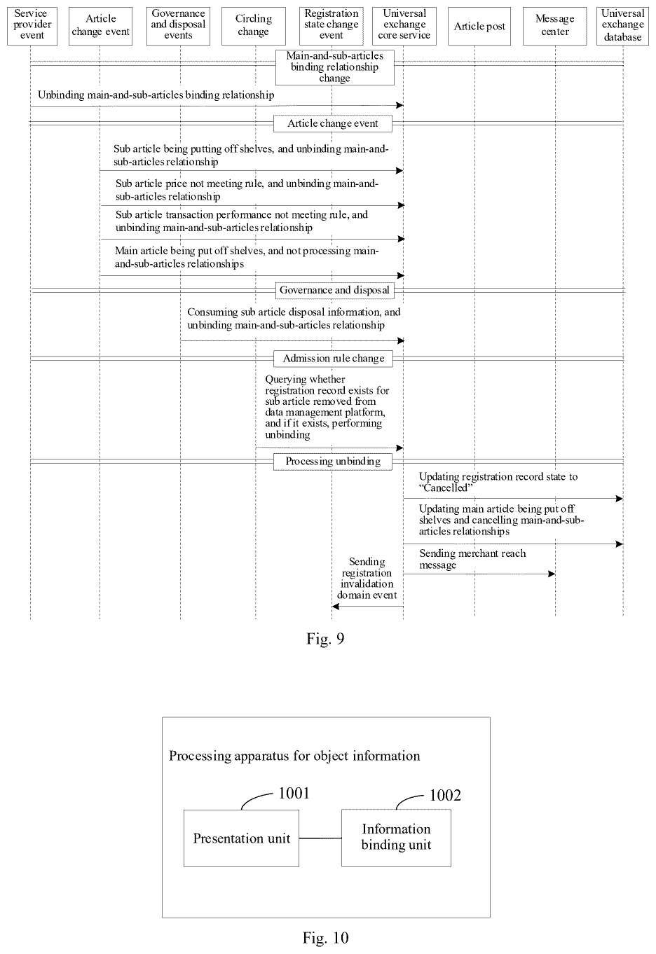

Exemplarily, as shown in FIG. 9, the event change information includes the sub article bein put off shelves, a sub article price not meeting the rule, and sub article transaction performance not meeting the rule.

In other embodiments, the binding rule changes, and the method may include: verifying, response to receiving rule update information of the sub object binding rule of the first target main object, in which an updated sub object binding rule is carried, respective sub objects bound with the first target main object according to the updated sub object binding rule, and unbinding a main-and-sub-objects binding relationship between a corresponding sub object and the first target main object if the verifying is not successful.

Exemplarily, as shown in FIG. 9, the sub object binding rule includes an admission rule change, and at this time, it can be queried whether a registration record exists for a sub article removed from a data management platform, and if it exists, unbinding is performed.

FIG. 10 is a schematic structural diagram of a processing apparatus for object information according to an embodiment of the present disclosure, where as shown in FIG. 10, the apparatus for processing object information includes:
a presentation unit 1001 configured to present, in a first application interface, a sub object registration entry of a first target main object; and
an information binding unit 1002 configured to establish, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects;
where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

According to one or more embodiments of the present disclosure, establishing, by the information binding unit 1002, in response to receiving the sub object registration information input by the first user based on the sub object registration entry of the first target main object, the main-and-sub-objects binding relationship between the sub object and the first target main object includes: presenting, in response to receiving a trigger operation on the sub object registration entry of the first target main object, a sub object registration interface, where the sub object registration interface includes a first entry for inputting the sub object and a second entry for inputting sub object information; acquiring the sub object input by the first user based on the first entry and the sub object information input by the first user based on the second entry; and establishing the main-and-sub-objects binding relationship between the sub object and the first target main object, and adding the sub object information into a sub object list corresponding to the first target main object, where the sub object list includes sub object information of respective sub objects for which the main-and-sub-objects binding relationships are established with the first target main object.

According to one or more embodiments of the present disclosure, presenting, by the presentation unit 1001, in the first application interface, the sub object registration entry of the first target main object includes: receiving a main object creation request for the first target main object, where the main object creation request carries main object information of the first target main object; and performing at least one of the following: generating the order information for the first target main object according to the main object information, presenting, in the second application interface of the second user, the order information for the first target main object, and presenting an interface switching entry for the first application interface corresponding to the first target main object, and in response to a trigger operation on the interface switching entry, presenting the sub object registration entry of the first target main object in the first application interface; sending sub object registration information for the first target main object to a first target user, where the sub object registration information is used for indicating sub object registration information to be input by the first target user based on the sub object registration entry of the first target main object, and the first target user is the first user meeting a sub object binding rule of the first target main object; or creating main object resource deduction information corresponding to the first target main object.

According to one or more embodiments of the present disclosure, the main object information includes the sub object binding rule; and correspondingly, establishing, by the information binding unit 1002, in response to receiving the sub object registration information input by the first user based on the sub object registration entry of the first target main object, the main-and-sub-objects binding relationship between the sub object and the first target main object includes: verifying, in response to receiving the sub object registration information input by the first user based on the sub object registration entry of the first target main object, the sub object registration information according to the sub object binding rule of the first target main object; and performing at least one of the following: establishing the main-and-sub-objects binding relationship between the sub object and the first target main object or creating sub object resource deduction information corresponding to the sub object, if the verifying is successful; where the sub object registration information includes a sub object identification, a sub object type, sub object resource information, and sub object historical interaction information; and the sub object binding rule includes one or more of: the sub object identification including a preset character, the sub object type being a preset type, the sub object resource information being within a preset resource information range, and the sub object historical interaction information meeting a preset condition.

According to one or more embodiments of the present disclosure, the information binding unit 1002 is further configured to: acquire a candidate sub object meeting the sub object binding rule according to the sub object binding rule of the first target main object; and establish a main-and-sub-objects binding relationship between the candidate sub object and the first target main object; or send a binding notification message to the first user corresponding to the candidate sub object, and establish, in response to a confirmation operation of the first user based on the binding notification message, a main-and-sub-objects binding relationship between the candidate sub object and the first target main object.

According to one or more embodiments of the present disclosure, the apparatus further includes: an unbinding unit configured to perform at least one of the following: unbinding, in response to receiving event change information of the sub object, the main-and-sub-objects binding relationship between the sub object and the first target main object, where the event change information includes one or more of: the first user no longer providing the sub object, sub object resource information of the sub object being not within a preset resource information range, or historical interaction information of the sub object not meeting a preset condition; or verifying, in response to receiving rule update information of sub object binding rule of the first target main object, in which an updated sub object binding rule is carried, respective sub objects bound with the first target main object according to the updated sub object binding rule, and unbinding a main-and-sub-objects binding relationship between a corresponding sub object and the first target main object if the verifying is not successful.

According to one or more embodiments of the present disclosure, the apparatus further includes: an exchange unit configured to present, in a third application interface, an exchange entry of a second target main object, where the second target main object is a main object having already been ordered by a third user based on the order information, and the third user is a user ordering the second target main object; acquire, in response to receiving a trigger operation on the exchange entry of the second target main object, sub object information of respective sub objects for which main-and-sub-objects binding relationships are established with the second target main object; and present sub object list information in a sub object exchange interface, where the sub object list information includes the sub object information of the respective sub objects for which the main-and-sub-objects binding relationships are established with the second target main object.

According to one or more embodiments of the present disclosure, acquiring, by the exchange unit, the sub object information of the respective sub objects for which the main-and-sub-objects binding relationships are established with the second target main object includes: acquiring, according to the second target main object, a plurality of sub objects for which the binding relationships have been established with the second target main object from binding record information of the second target main object; and acquiring binding state information of each sub object, and acquiring the sub object information of the sub object if the binding state information is used for indicating that the sub object and the second target main object are in a binding state.

According to one or more embodiments of the present disclosure, the sub object information includes sub object exchange information and a sub object exchange entry; and the exchange unit is further configured to: exchange, in response to receiving a trigger operation on the sub object exchange entry, the sub object, and present, in an exchange result interface, use voucher information for the sub object, where the sub object exchange information of the sub object includes sub object resource information and object resource deduction information, and the object resource deduction information is a sum of main object resource deduction information of the second target main object and sub object resource deduction information of the sub object.

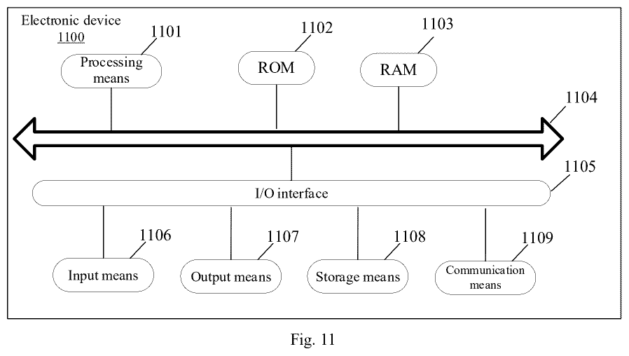

Referring to FIG. 11, a schematic structural diagram of an electronic device 1100 suitable for implementing an embodiment of the present disclosure is shown, where the electronic device 1100 may be a terminal device or a server. The terminal device may include, but is not limited to, a mobile terminal such as a mobile phone, laptop, digital broadcast receiver, personal digital assistant (PDA for short), Tablet computer, portable multimedia player (PMP for short), and vehicle-mounted terminal (e.g., vehicle-mounted navigation terminal), and a fixed terminal such as a Digital TV and desk computer. The electronic device shown in FIG. 11 is only an example, and should not bring any limitation to the functions and use scope of the embodiment of the present disclosure.

As shown in FIG. 11, the electronic device 1100 may include a processing means (e.g., a central processing unit, processing unit, etc.) 1101, which may perform various suitable actions and processes according to a program stored in a read only memory (ROM for short) 1102 or a program loaded from a storage means 1108 into a random access memory (RAM for short) 1103. In the RAM 1103, various programs and data required for the operation of the electronic device 1100 are also stored. The processing means 1101, the ROM 1102, and the RAM 1103 are connected to each other by a bus 1104. An input/output (I/O) interface 1105 is also connected to the bus 1104.

Generally, the following means may be connected to the I/O interface 1105: an input means 1106 including, for example, a touch screen, touch pad, keyboard, mouse, camera, microphone, accelerometer, gyroscope, etc.; an output means 1107 including, for example, a liquid crystal display (LCD for short), speaker, vibrator, etc.; the storage means 1108, including, for example, a magnetic tape, hard disk, etc.; and a communication means 1109. The communication means 1109 may allow the electronic device 1100 to communicate wirelessly or by wire with other devices to exchange data. While FIG. 11 illustrates the electronic device 1100 having various means, it should be understood that there is no requirement that all illustrated means are implemented or provided. More or fewer devices may be alternatively implemented or provided.

In particular, according to embodiments of the present disclosure, the processes described above with reference to the flow diagrams may be implemented as a computer software program. For example, an embodiment of the present disclosure includes a computer program product including a computer program carried on a computer-readable medium, the computer program including program code for performing the method illustrated by the flow diagram. In such an embodiment, the computer program may be downloaded and installed from a network via the communication means 1109, or installed from the storage means 1108, or installed from the ROM 1102. When executed by the processing means 1101, the computer program performs the above functions defined in the method of the embodiment of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, portable computer diskette, hard disk, random access memory (RAM), read only memory (ROM), erasable programmable read-only memory (EPROM or flash memory), optical fiber, portable compact disc read-only memory (CD-ROM), optical storage device, magnetic storage device, or any suitable combination of the foregoing. In the present disclosure, the computer-readable storage medium may be any tangible medium containing or storing a program, where the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, where the computer-readable signal medium can send, propagate, or transmit a program for use by or in conjunction with an instruction execution system, apparatus, or device. The program code contained on the computer-readable medium may be transmitted using any appropriate medium, including but not limited to: a wire, optical cable, RF (Radio Frequency), etc., or any suitable combination of the foregoing.

The above computer-readable medium may be contained in the above electronic device; or may exist separately without being assembled into the electronic device.

The above computer-readable medium has thereon carried one or more programs which, when executed by the electronic device, cause the electronic device to perform the method shown in the above embodiments.

Computer program code for performing the operation of the present disclosure may be written in one or more programming languages or a combination thereof, where the above programming language includes but is not limited to an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN for short) or a wide area network (WAN for short), or may be connected to an external computer (for example, through the Internet using an Internet service provider).

The flow diagrams and block diagrams in the drawings illustrate the possibly implemented architecture, functions, and operations of the system, method and computer program product According to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself, for example, the first acquisition unit can also be described as a “unit configured to acquire at least two internet protocol addresses”.

The functions described above herein may be executed, at least partially, by one or more hardware logic components. For example, without limitation, a hardware logic component of an exemplary type that may be used includes: a field programmable gate array (FPGA), application specific integrated circuit (ASIC), application specific standard article (ASSP), system on chip (SOC), complex programmable logic device (CPLD), and the like.

In a first aspect, according to one or more embodiments of the present disclosure, there is provided a processing method for object information, including:
presenting, in a first application interface, a sub object registration entry of a first target main object; and
establishing, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects;
where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

According to one or more embodiments of the present disclosure, establishing, in response to receiving the sub object registration information input by the first user based on the sub object registration entry of the first target main object, the main-and-sub-objects binding relationship between the sub object and the first target main object includes: presenting, in response to receiving a trigger operation on the sub object registration entry of the first target main object, a sub object registration interface, where the sub object registration interface includes a first entry for inputting the sub object and a second entry for inputting sub object information; acquiring the sub object input by the first user based on the first entry and the sub object information input by the first user based on the second entry; and establishing the main-and-sub-objects binding relationship between the sub object and the first target main object, and adding the sub object information into a sub object list corresponding to the first target main object, where the sub object list includes sub object information of respective sub objects for which the main-and-sub-objects binding relationships are established with the first target main object.

According to one or more embodiments of the present disclosure, presenting, in the first application interface, the sub object registration entry of the first target main object includes: receiving a main object creation request for the first target main object, where the main object creation request carries main object information of the first target main object; and performing at least one of the following: generating the order information for the first target main object according to the main object information, presenting, in the second application interface of the second user, the order information for the first target main object, and presenting an interface switching entry for the first application interface corresponding to the first target main object, and in response to a trigger operation on the interface switching entry, presenting the sub object registration entry of the first target main object in the first application interface; sending sub object registration information for the first target main object to a first target user, where the sub object registration information is used for indicating sub object registration information to be input by the first target user based on the sub object registration entry of the first target main object, and the first target user is the first user meeting a sub object binding rule of the first target main object; o r creating main object resource deduction information corresponding to the first target main object.

According to one or more embodiments of the present disclosure, the main object information includes the sub object binding rule; and correspondingly, establishing, in response to receiving the sub object registration information input by the first user based on the sub object registration entry of the first target main object, the main-and-sub-objects binding relationship between the sub object and the first target main object includes: verifying, in response to receiving the sub object registration information input by the first user based on the sub object registration entry of the first target main object, the sub object registration information according to the sub object binding rule of the first target main object; and performing at least one of the following: establishing the main-and-sub-objects binding relationship between the sub object and the first target main object or creating sub object resource deduction information corresponding to the sub object, if the verifying is successful; where the sub object registration information includes a sub object identification, a sub object type, sub object resource information, and sub object historical interaction information; and the sub object binding rule includes one or more of: the sub object identification including a preset character, the sub object type being a preset type, the sub object resource information being within a preset resource information range, and the sub object historical interaction information meeting a preset condition.

According to one or more embodiments of the present disclosure, the method further includes: acquiring a candidate sub object meeting the sub object binding rule according to the sub object binding rule of the first target main object; and establishing a main-and-sub-objects binding relationship between the candidate sub object and the first target main object; or, sending a binding notification message to the first user corresponding to the candidate sub object, and establishing, in response to a confirmation operation of the first user based on the binding notification message, a main-and-sub-objects binding relationship between the candidate sub object and the first target main object.

According to one or more embodiments of the present disclosure, the method further includes performing at least one of the following: unbinding, in response to receiving event change information of the sub object, the main-and-sub-objects binding relationship between the sub object and the first target main object, where the event change information includes one or more of: the first user no longer providing the sub object, sub object resource information of the sub object being not within a preset resource information range, or historical interaction information of the sub object not meeting a preset condition; or verifying, in response to receiving rule update information of sub object binding rule of the first target main object, in which an updated sub object binding rule is carried, respective sub objects bound with the first target main object according to the updated sub object binding rule, and unbinding a main-and-sub-objects binding relationship between a corresponding sub object and the first target main object if the verifying is not successful.

According to one or more embodiments of the present disclosure, the method further includes: presenting, in a third application interface, an exchange entry of a second target main object, where the second target main object is a main object having already been ordered by a third user based on the order information, and the third user is a user ordering the second target main object; acquiring, in response to receiving a trigger operation on the exchange entry of the second target main object, sub object information of respective sub objects for which main-and-sub-objects binding relationships are established with the second target main object; and presenting sub object list information in a sub object exchange interface, where the sub object list information includes the sub object information of the respective sub objects for which the main-and-sub-objects binding relationships are established with the second target main object.

According to one or more embodiments of the present disclosure, acquiring the sub object information of the respective sub objects for which the main-and-sub-objects binding relationships are established with the second target main object includes: acquiring, according to the second target main object, a plurality of sub objects for which the binding relationships have been established with the second target main object from binding record information of the second target main object; and acquiring binding state information of each sub object, and acquiring the sub object information of the sub object if the binding state information is used for indicating that the sub object and the second target main object are in a binding state.

According to one or more embodiments of the present disclosure, the sub object information includes sub object exchange information and a sub object exchange entry; and the method further includes: exchanging, in response to receiving a trigger operation on the sub object exchange entry, the sub object, and presenting, in an exchange result interface, use voucher information for the sub object, where the sub object exchange information of the sub object includes sub object resource information and object resource deduction information, and the object resource deduction information is a sum of main object resource deduction information of the second target main object and sub object resource deduction information of the sub object.

In a second aspect, according to one or more embodiments of the present disclosure, there is provided a processing apparatus for object information, including:
a presentation unit configured to present, in a first application interface, a sub object registration entry of a first target main object; and
an information binding unit configured to establish, in response to receiving sub object registration information input by a first user based on the sub object registration entry of the first target main object, a main-and-sub-objects binding relationship between a sub object and the first target main object, where the first target main object has main-and-sub-objects binding relationships with a plurality of sub objects, and a main store identification corresponding to the first target main object is different from sub store identifications corresponding to respective sub objects;
where associated cooperation information with a second user is displayed in the first application interface, the associated cooperation information is used for indicating that introduction information and order information for the first target main object are presented in a second application interface of the second user, the first user is a user providing the sub object, and the second user is a user with a popularity value greater than a first preset value.

According to one or more embodiments of the present disclosure, establishing, by the information binding unit, in response to receiving the sub object registration information input by the first user based on the sub object registration entry of the first target main object, the main-and-sub-objects binding relationship between the sub object and the first target main object includes: presenting, in response to receiving a trigger operation on the sub object registration entry of the first target main object, a sub object registration interface, where the sub object registration interface includes a first entry for inputting the sub object and a second entry for inputting sub object information; acquiring the sub object input by the first user based on the first entry and the sub object information input by the first user based on the second entry; and establishing the main-and-sub-objects binding relationship between the sub object and the first target main object, and adding the sub object information into a sub object list corresponding to the first target main object, where the sub object list includes sub object information of respective sub objects for which the main-and-sub-objects binding relationships are established with the first target main object.

According to one or more embodiments of the present disclosure, presenting, by the presentation unit, in the first application interface, the sub object registration entry of the first target main object includes: receiving a main object creation request for the first target main object, where the main object creation request carries main object information of the first target main object; and performing at least one of the following: generating the order information for the first target main object according to the main object information, presenting, in the second application interface of the second user, the order information for the first target main object, and presenting an interface switching entry for the first application interface corresponding to the first target main object, and in response to a trigger operation on the interface switching entry, presenting the sub object registration entry of the first target main object in the first application interface; sending sub object registration information for the first target main object to a first target user, where the sub object registration information is used for indicating sub object registration information to be input by the first target user based on the sub object registration entry of the first target main object, and the first target user is the first user meeting a sub object binding rule of the first target main object; or creating main object resource deduction information corresponding to the first target main object.

According to one or more embodiments of the present disclosure, the main object information includes the sub object binding rule; and correspondingly, establishing, by the information binding unit, in response to receiving the sub object registration information input by the first user based on the sub object registration entry of the first target main object, the main-and-sub-objects binding relationship between the sub object and the first target main object includes: verifying, in response to receiving the sub object registration information input by the first user based on the sub object registration entry of the first target main object, the sub object registration information according to the sub object binding rule of the first target main object; and performing at least one of the following: establishing the main-and-sub-objects binding relationship between the sub object and the first target main object or creating sub object resource deduction information corresponding to the sub object, if the verifying is successful, where the sub object registration information includes a sub object identification, a sub object type, sub object resource information, and sub object historical interaction information; and the sub object binding rule includes one or more of: the sub object identification including a preset character, the sub object type being a preset type, the sub object resource information being within a preset resource information range, and the sub object historical interaction information meeting a preset condition.

According to one or more embodiments of the present disclosure, the information binding unit is further configured to: acquire a candidate sub object meeting the sub object binding rule according to the sub object binding rule of the first target main object; and establish a main-and-sub-objects binding relationship between the candidate sub object and the first target main object; or, send a binding notification message to the first user corresponding to the candidate sub object, and establish, in response to a confirmation operation of the first user based on the binding notification message, a main-and-sub-objects binding relationship between the candidate sub object and the first target main object.

According to one or more embodiments of the present disclosure, the apparatus further includes: an unbinding unit configured to performing at least one of the following: unbinding, in re sponse to receiving event change information of the sub object, the main-and-sub-objects binding relationship between the sub object and the first target main object, where the event change information includes one or more of: the first user no longer providing the sub object, sub object resource information of the sub object being not within a preset resource information range, or historical interaction information of the sub object not meeting a preset condition; or verifying, in response to receiving rule update information of sub object binding rule of the first target main object, in which an updated sub object binding rule is carried, respective sub objects bound with the first target main object according to the updated sub object binding rule, and unbinding a main-and-sub-objects binding relationship between a corresponding sub object and the first target main object if the verifying is not successful.

According to one or more embodiments of the present disclosure, the apparatus further includes: an exchange unit configured to present, in a third application interface, an exchange entry of a second target main object, where the second target main object is a main object having already been ordered by a third user based on the order information, and the third user is a user ordering the second target main object; acquire, in response to receiving a trigger operation on the exchange entry of the second target main object, sub object information of respective sub objects for which main-and-sub-objects binding relationships are established with the second target main object; and present sub object list information in a sub object exchange interface, where the sub object list information includes the sub object information of the respective sub objects for which the main-and-sub-objects binding relationships are established with the second target main object.

According to one or more embodiments of the present disclosure, acquiring, by the exchange unit, the sub object information of the respective sub objects for which the main-and-sub-objects binding relationships are established with the second target main object includes: acquiring, according to the second target main object, a plurality of sub objects for which the binding relationships have been established with the second target main object from binding record information of the second target main object; and acquiring binding state information of each sub object, and acquiring the sub object information of the sub object if the binding state information is used for indicating that the sub object and the second target main object are in a binding state.

According to one or more embodiments of the present disclosure, the sub object information includes sub object exchange information and a sub object exchange entry; and the exchange unit is further configured to: exchange, in response to receiving a trigger operation on the sub object exchange entry, the sub object, and present, in an exchange result interface, use voucher information for the sub object, where the sub object exchange information of the sub object includes sub object resource information and object resource deduction information, and the object resource deduction information is a sum of main object resource deduction information of the second target main object and sub object resource deduction information of the sub object.

In a third aspect, according to one or more embodiments of the present disclosure, there is provided an electronic device, including: at least one processor and a memory,
where the memory has stored therein computer-executable instructions; and
the at least one processor executes the computer-executable instructions stored in the memory to cause the at least one processor to perform the processing method for object information as described above in the first aspect and various possible designs of the first aspect.

In a fourth aspect, according to one or more embodiments of the present disclosure, there provided a computer-readable storage medium having stored therein computer-executable instructions which, when executed by a processor, implement the processing method for object information as described above in the first aspect and various possible designs of the first aspect.

In a fifth aspect, according to one or more embodiments of the present disclosure, there is provided a computer program product, including a computer program which, when executed by a processor, implements the processing method for object information as described above in the first aspect and various possible designs of the first aspect.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited thereto) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms in which the claims are implemented.

1. A processing method for object information, comprising:
presenting, in a first application interface, a sub object registration entry of a first main object; and
establishing, in response to receiving sub object registration information input by a first user based on the sub object registration entry of the first main object, a binding relationship between a sub object and the first main object, wherein the first main object has binding relationships with a plurality of sub objects, and a main identification corresponding to the first main object is different from sub identifications corresponding to respective sub objects;
wherein associated cooperation information with a second user is displayed in the first application interface, the associated cooperation information is used for indicating that introduction information and order information for the first main object are presented in a second application interface of the second user, the first user is a user providing the sub object, and the second user is a user with a popularity value greater than a first preset value.

2. The method according to claim 1, wherein establishing, in response to receiving the sub object registration information input by the first user based on the sub object registration entry of the first main object, the binding relationship between the sub object and the first main object comprises:
presenting, in response to receiving a trigger operation on the sub object registration entry of the first main object, a sub object registration interface, wherein the sub object registration interface comprises a first entry for inputting the sub object and a second entry for inputting sub object information;
acquiring the sub object input by the first user based on the first entry and the sub object information input by the first user based on the second entry; and
establishing the binding relationship between the sub object and the first main object, and adding the sub object information into a sub object list corresponding to the first main object, wherein the sub object list comprises sub object information of respective sub objects for which the binding relationships are established with the first main object.

3. The method according to claim 1, wherein presenting, in the first application interface, the sub object registration entry of the first main object comprises:
receiving a main object creation request for the first main object, wherein the main object creation request carries main object information of the first main object; and
performing at least one of the following: generating the order information for the first main object according to the main object information, presenting, in the second application interface of the second user, the order information for the first main object, and presenting an interface switching entry for the first application interface corresponding to the first main object, and in response to a trigger operation on the interface switching entry, presenting the sub object registration entry of the first main object in the first application interface; sending sub object registration information for the first main object to a first target user, wherein the sub object registration information is used for indicating sub object registration information to be input by the first target user based on the sub object registration entry of the first main object, and the first target user is the first user meeting a sub object binding rule of the first main object; or creating main object resource deduction information corresponding to the first main object.

4. The method according to claim 3, wherein the main object information comprises the sub object binding rule; and
correspondingly, establishing, in response to receiving the sub object registration information input by the first user based on the sub object registration entry of the first main object, the binding relationship between the sub object and the first main object comprises:
verifying, in response to receiving the sub object registration information input by the first user based on the sub object registration entry of the first main object, the sub object registration information according to the sub object binding rule of the first main object; and
performing at least one of the following: establishing the binding relationship between the sub object and the first main object or creating sub object resource deduction information corresponding to the sub object, if the verifying is successful;
wherein the sub object registration information comprises a sub object identification, a sub object type, sub object resource information, and sub object historical interaction information; and the sub object binding rule comprises one or more of: the sub object identification comprising a preset character, the sub object type being a preset type, the sub object resource information being within a preset resource information range, and the sub object historical interaction information meeting a preset condition.

5. The method according to claim 4, further comprising:
acquiring a candidate sub object meeting the sub object binding rule according to the sub object binding rule of the first main object; and
establishing a binding relationship between the candidate sub object and the first main object; or, sending a binding notification message to the first user corresponding to the candidate sub object, and establishing, in response to a confirmation operation of the first user based on the binding notification message, a binding relationship between the candidate sub object and the first main object.

6. The method according to claim 1, further comprising performing at least one of the following:
unbinding, in response to receiving event change information of the sub object, the binding relationship between the sub object and the first main object, wherein the event change information comprises one or more of: the first user no longer providing the sub object, sub object resource information of the sub object being not within a preset resource information range, or historical interaction information of the sub object not meeting a preset condition; or
verifying, in response to receiving rule update information of sub object binding rule of the first main object, in which an updated sub object binding rule is carried, respective sub objects bound with the first main object according to the updated sub object binding rule, and unbinding a binding relationship between a corresponding sub object and the first main object if the verifying is not successful.

7. The method according to claim 1, further comprising:
presenting, in a third application interface, an exchange entry of a second main object, wherein the second main object is a main object having already been ordered by a third user based on the order information, and the third user is a user ordering the second main object;
acquiring, in response to receiving a trigger operation on the exchange entry of the second main object, sub object information of respective sub objects for which binding relationships are established with the second main object; and
presenting sub object list information in a sub object exchange interface, wherein the sub object list information comprises the sub object information of the respective sub objects for which the binding relationships are established with the second main object.

8. The method according to claim 7, wherein acquiring the sub object information of the respective sub objects for which the binding relationships are established with the second main object comprises:
acquiring, according to the second main object, a plurality of sub objects for which the binding relationships have been established with the second main object from binding record information of the second main object; and
acquiring binding state information of each sub object, and acquiring the sub object information of the sub object if the binding state information is used for indicating that the sub object and the second main object are in a binding state.

9. The method according to claim 7, wherein the sub object information comprises sub object exchange information and a sub object exchange entry; and the method further comprises:
exchanging, in response to receiving a trigger operation on the sub object exchange entry, sub object, and presenting, in an exchange result interface, use voucher information for the sub object, wherein the sub object exchange information of the sub object comprises sub object resource information and object resource deduction information, and the object resource deduction information is a sum of main object resource deduction information of the second main object and sub object resource deduction information of the sub object.

10. An electronic device, comprising: a processor and a memory, wherein
the memory has stored therein computer-executable instructions; and
the processor executes the computer-executable instructions stored in the memory to cause the processor to perform the following processing operations for object information:
presenting, in a first application interface, a sub object registration entry of a first main object; and
establishing, in response to receiving sub object registration information input by a first user based on the sub object registration entry of the first main object, a binding relationship between a sub object and the first main object, wherein the first main object has binding relationships with a plurality of sub objects, and a main identification corresponding to the first main object is different from sub identifications corresponding to respective sub objects;
wherein associated cooperation information with a second user is displayed in the first application interface, the associated cooperation information is used for indicating that introduction information and order information for the first main object are presented in a second application interface of the second user, the first user is a user providing the sub object, and the second user is a user with a popularity value greater than a first preset value.

11. The electronic device according to claim 10, wherein establishing, in response to receiving the sub object registration information input by the first user based on the sub object registration entry of the first main object, the binding relationship between the sub object and the first main object comprises:
presenting, in response to receiving a trigger operation on the sub object registration entry of the first main object, a sub object registration interface, wherein the sub object registration interface comprises a first entry for inputting the sub object and a second entry for inputting sub object information;
acquiring the sub object input by the first user based on the first entry and the sub object information input by the first user based on the second entry; and
establishing the binding relationship between the sub object and the first main object, and adding the sub object information into a sub object list corresponding to the first main object, wherein the sub object list comprises sub object information of respective sub objects for which the binding relationships are established with the first main object.

12. The electronic device according to claim 10, wherein presenting, in the first application interface, the sub object registration entry of the first main object comprises:
receiving a main object creation request for the first main object, wherein the main object creation request carries main object information of the first main object; and
performing at least one of the following: generating the order information for the first main object according to the main object information, presenting, in the second application interface of the second user, the order information for the first main object, and presenting an interface switching entry for the first application interface corresponding to the first main object, and in response to a trigger operation on the interface switching entry, presenting the sub object registration entry of the first main object in the first application interface; sending sub object registration information for the first main object to a first target user, wherein the sub object registration information is used for indicating sub object registration information to be input by the first target user based on the sub object registration entry of the first main object, and the first target user is the first user meeting a sub object binding rule of the first main object; or creating main object resource deduction information corresponding to the first main object;

13. The electronic device according to claim 12, wherein the main object information comprises the sub object binding rule; and
correspondingly, establishing, in response to receiving the sub object registration information input by the first user based on the sub object registration entry of the first main object, the binding relationship between the sub object and the first main object comprises:
verifying, in response to receiving the sub object registration information input by the first user based on the sub object registration entry of the first main object, the sub object registration information according to the sub object binding rule of the first main object; and
performing at least one of the following: establishing the binding relationship between the sub object and the first main object or creating sub object resource deduction information corresponding to the sub object, if the verifying is successful;
wherein the sub object registration information comprises a sub object identification, a sub object type, sub object resource information, and sub object historical interaction information; and the sub object binding rule comprises one or more of: the sub object identification comprising a preset character, the sub object type being a preset type, the sub object resource information being within a preset resource information range, and the sub object historical interaction information meeting a preset condition.

14. The electronic device according to claim 13, wherein the processor executes the computer-executable instructions stored in the memory to cause the processor to further perform the following operations:
acquiring a candidate sub object meeting the sub object binding rule according to the sub object binding rule of the first main object; and
establishing a binding relationship between the candidate sub object and the first main object; or, sending a binding notification message to the first user corresponding to the candidate sub object, and establishing, in response to a confirmation operation of the first user based on the binding notification message, a binding relationship between the candidate sub object and the first main object.

15. A non-transitory computer-readable storage medium, wherein the computer-readable storage medium has stored therein computer-executable instructions which, when executed by a processor, implement the following processing operations for object information:
presenting, in a first application interface, a sub object registration entry of a first main object; and
establishing, in response to receiving sub object registration information input by a first user based on the sub object registration entry of the first main object, a binding relationship between a sub object and the first main object, wherein the first main object has binding relationships with a plurality of sub objects, and a main identification corresponding to the first main object is different from sub identifications corresponding to respective sub objects;
wherein associated cooperation information with a second user is displayed in the first application interface, the associated cooperation information is used for indicating that introduction information and order information for the first main object are presented in a second application interface of the second user, the first user is a user providing the sub object, and the second user is a user with a popularity value greater than a first preset value.

16. The storage medium according to claim 15, wherein establishing, in response to receiving the sub object registration information input by the first user based on the sub object registration entry of the first main object, the binding relationship between the sub object and the first main object comprises:
presenting, in response to receiving a trigger operation on the sub object registration entry of the first main object, a sub object registration interface, wherein the sub object registration interface comprises a first entry for inputting the sub object and a second entry for inputting sub object information;
acquiring the sub object input by the first user based on the first entry and the sub object information input by the first user based on the second entry; and
establishing the binding relationship between the sub object and the first main object, and adding the sub object information into a sub object list corresponding to the first main object, wherein the sub object list comprises sub object information of respective sub objects for which the binding relationships are established with the first main object.

17. The storage medium according to claim 15, wherein presenting, in the first application interface, the sub object registration entry of the first main object comprises:
receiving a main object creation request for the first main object, wherein the main object creation request carries main object information of the first main object; and
performing at least one of the following: generating the order information for the first main object according to the main object information, presenting, in the second application interface of the second user, the order information for the first main object, and presenting an interface switching entry for the first application interface corresponding to the first main object, and in response to a trigger operation on the interface switching entry, presenting the sub object registration entry of the first main object in the first application interface; sending sub object registration information for the first main object to a first target user, wherein the sub object registration information is used for indicating sub object registration information to be input by the first target user based on the sub object registration entry of the first main object, and the first target user is the first user meeting a sub object binding rule of the first main object; or creating main object resource deduction information corresponding to the first main object.

18. The storage medium according to claim 17, wherein the main object information comprises the sub object binding rule; and
correspondingly, establishing, in response to receiving the sub object registration information input by the first user based on the sub object registration entry of the first main object, the binding relationship between the sub object and the first main object comprises:
verifying, in response to receiving the sub object registration information input by the first user based on the sub object registration entry of the first main object, the sub object registration information according to the sub object binding rule of the first main object; and
performing at least one of the following: establishing the binding relationship between the sub object and the first main object or creating sub object resource deduction information corresponding to the sub object, if the verifying is successful;
wherein the sub object registration information comprises a sub object identification, a sub object type, sub object resource information, and sub object historical interaction information; and the sub object binding rule comprises one or more of: the sub object identification comprising a preset character, the sub object type being a preset type, the sub object resource information being within a preset resource information range, and the sub object historical interaction information meeting a preset condition.

19. The storage medium according to claim 18, wherein the computer-executable instructions, when executed by the processor, further implement the following operations:
acquiring a candidate sub object meeting the sub object binding rule according to the sub object binding rule of the first main object; and
establishing a binding relationship between the candidate sub object and the first main object; or, sending a binding notification message to the first user corresponding to the candidate sub object, and establishing, in response to a confirmation operation of the first user based on the binding notification message, a binding relationship between the candidate sub object and the first main object.

20. The storage medium according to claim 15, wherein the computer-executable instructions, when executed by the processor, further implement at least one of the following operations:
unbinding, in response to receiving event change information of the sub object, the binding relationship between the sub object and the first main object, wherein the event change information comprises one or more of: the first user no longer providing the sub object, sub object resource information of the sub object being not within a preset resource information range, or historical interaction information of the sub object not meeting a preset condition; or
verifying, in response to receiving rule update information of sub object binding rule of the first main object, in which an updated sub object binding rule is carried, respective sub objects bound with the first main object according to the updated sub object binding rule, and unbinding a binding relationship between a corresponding sub object and the first main object if the verifying is not successful.
